(19) United States
(12) Patent Application Publication
(10) Pub. No.: US 2008/0033820 A1
(43) Pub. Date: Feb. 7, 2008

(54) METHODS FOR SECURITY SERVICE THROUGH TITLE, CASUALTY INSURANCE, ESCROW, AND RELATED SERVICE COMPANIES

(76) Inventor: Marlan Clave Walker, Santa Clara, UT (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/832,608

(22) Filed: Aug. 1, 2007

Related U.S. Application Data
(60) Provisional application No. 60/821,250, filed on Aug. 2, 2006.

(51) Int. Cl. G06Q 30/00

(52) U.S. Cl. 705/14

(57) ABSTRACT

Improvement of a property's security features, such a rekeying, is offered by an escrow, title, insurance, banking, or loan-related companies as part of their services to the purchasers. Once ratified by the purchaser, the company coordinates with a provider of a particular security feature for the installation of or providing of the security related good or service in addition to the non-security related service provided.

### RELATED APPLICATIONS

This application claims the Paris Convention priority of U.S. Provisional Application Ser. No. 60/821,250, filed Aug. 2, 2006 entitled “Methods for Security Service Through Title, Casualty Insurance, and Escrow Service Companies,” the contents of which are incorporated by reference.

### BACKGROUND

This invention relates to a system and methodology for marketing locksmith services through title, escrow service, property and casualty insurance and lending companies, and specifically (i) to marketing services to re-key locks through escrow, lending and title service companies as a part of the purchase and/or refinancing of real estate, and (ii) to marketing locksmith services through property and casualty insurance companies either as a promotion to sell such insurance to new customers or at the time that an application is made for such insurance.

### SUMMARY OF THE INVENTION

Improvement of a property's security features, such a rekeying, is offered by an escrow, title, insurance, banking, or loan-related companies as part of their services to the purchasers. Once ratified by the purchaser, the company coordinates with a provider of a particular security feature for the installation of or providing of the security related good or service in addition to the non-security related service provided.

According to a feature of the present disclosure, a method is disclosed comprising identifying a potential purchaser of a property, providing a communication to the potential purchaser for security related products and services, and coordinating with a provider of security-related products or services for the property for the purchaser. The identification of the purchaser is made in conjunction with the providing of an unrelated property acquisition-type service.

According to a feature of the present disclosure, a method is disclosed comprising offering rekeying services to a purchaser of a property. The offer is made by an entity offering escrow products or services; title products or services; insurance products or services; banking products or services; or lending products or services.

According to a feature of the present disclosure, a method is disclosed comprising in conjunction with the offer of or providing of at least one of escrow, title, insurance, banking, or loan-related services: identifying a purchaser of a property, providing for a communication for the rekeying of the property's locks, and coordinating with a locksmith to have the property's locks rekeyed.

According to a feature of the present disclosure, products by the processes are also expressly contemplated.

### DRAWINGS

The above-mentioned features and objects of the present disclosure will become more apparent with reference to the following description taken in conjunction with the accompanying drawings wherein like reference numerals denote like elements and in which:

FIG. 1 is a flowchart of an embodiment of the process of offering security related products as part of an escrow, title, insurance, banking, or loan-related type service; and

FIG. 2 is a flowchart of an embodiment demonstrating offering a rekeying service as part of an escrow process.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, biological, electrical, functional, and other changes may be made without departing from the scope of the present invention. The following detailed description is, therefore, not to be taken in a limiting sense, and the scope of the present invention is defined only by the appended claims. As used in the present disclosure, the term “or” shall be understood to be defined as a logical disjunction and shall not indicate an exclusive disjunction unless expressly indicated as such or notated as “xor.”

During the purchase of a new property, purchasers often accept substandard security because they fail to consider security ramifications during the purchase process. After the sale is complete and the purchaser takes possession of a property, they must often remember, coordinate, and schedule for security improvements and necessities of their own accord. Often, because the purchaser is not intimately familiar with the property, security related improvements and necessities are left unidentified, posing security related risks. Similarly, purchasers may not be familiar with energy efficiency options that may be installed to improve energy efficiency, reduce operating costs, and increase of overall value of a property. In many instances, escrow, title, insurance, banking, and loan-related companies may, as a value added, communicate to purchasers of new properties needs or suggestions for improving the security of the property that the purchaser might otherwise not think about during the purchase process.

The present disclosure discloses methods of offering security related goods or services and coordinating with providers to provide the security related good or service. Although the disclosure describes the methods with respect to the rekeying of locks, a person of ordinary skill in the art would understand and appreciate that the principles taught herein apply more generally to all security related features of a property including, for example, fences, alarms, improved structural features, such as improved doors and windows. Moreover, the instant principles also apply to offer of and coordinating of installation or improvement of goods and services designed to make properties more energy efficient.

As a matter of ordinary security, locks should be rekeyed whenever property is sold or otherwise transferred. The new owner cannot know with any certainty how many keys exist or who might have possession of those keys. Historically, a new owner of property arranges to have locks replaced or rekeyed after he or she obtains ownership and possession of the property, if at all. In order to do this, the owner has to search the yellow pages or internet for a qualified locksmith. Even when he finds a locksmith, the owner does not know the background or qualifications of the locksmith. Most locksmiths are independent and operate out of a small shop or mobile vehicle. As is more often the case, a new owner simply fails to think about this important security issue with all of the other issues involved in purchasing the property. Moreover, existing property owners should consider changing or rekeying locks after certain events occur, such as the loss of keys, burglary, or simply the passage of time.

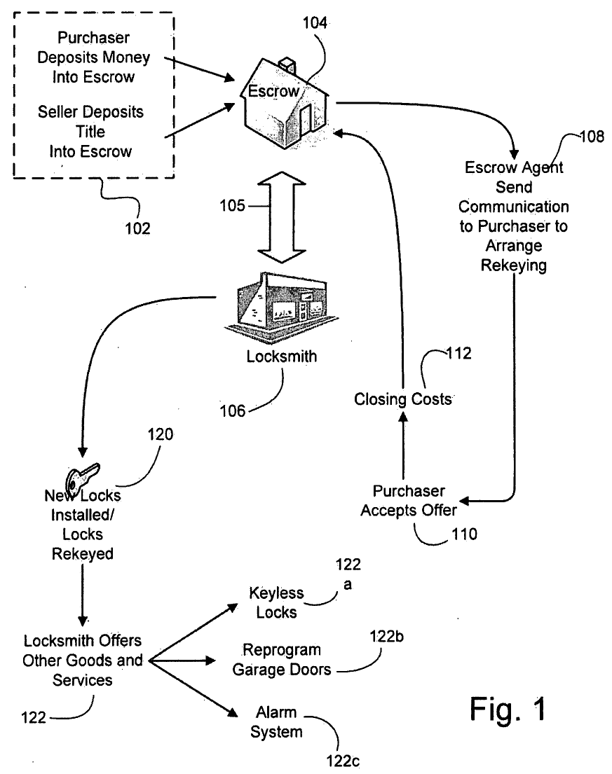

Escrow companies are ideally situated to offer and tie closing costs into services such as rekeying locks, as illustrated generally in FIG. 1. Moreover, insurance companies and lending institutions have a vested interest in maintaining appropriate levels of security for new properties. Consequently, escrow companies, insurance companies, lending instructions, and other companies with which a purchaser deals at the time of their purchase of a property, as a value added, automatically provides services such as rekeying of house locks or useful modifications such as energy efficiency improvements at the time of or as a part of the services offered. It will be understood by artisans that each of these type of companies offer a traditional service related to the purchase of property; reference to one type of company will be understood to be interchangeable with another such company and its related set of non-security related services (e.g., escrow companies are interchangeable with banks or title insurance companies).

Another aspect of associating locksmith services to the purchase of property is providing a platform for contractors to up-sell other goods and services that may useful to a new owner. For example, a locksmith visiting the property of a new owner to re-key the home might observe children in the home. The locksmith might suggest to the new owner installation of biometric-type keys in addition to traditional style keys, which would allow a new owner to avoid the necessity of giving children physical keys that might be lost or stolen and pose security risks. Similarly, locksmiths can upsell security systems, insurance, other devices and services that would useful to new owners.

According to embodiments and in the case of title and escrow services 104 as illustrated in FIG. 1, communication 108, such as a letter, is initiated at the time that escrow is opened 102 or an application for title insurance is made, for example. According to embodiments, when a new owner opens escrow account 102 with a title and escrow service company, communication 108, such as a letter, is automatically generated for their account. The letter may be immediately generated and delivered to the potential new owner at the time other documents are executed or the letter may be automatically sent to the potential new owner a set period of time after the account is opened. According to embodiments, reminder letters may also be sent if a potential new owner fails to reply to an initial letter a set period of time after the initial letter is sent or after escrow closes. According to embodiments, the purchaser then opt to have the property rekeyed in operation 110.

According to similar embodiments and in addition to or in place of sending letters, escrow agents may verbally offer rekeying type services to potential purchasers. The agent may do so at the time of the closing or at other times that the agent deems the potential new owner may be receptive to an offer of rekeying. The agent may make the offer in conjunction with education regarding security risks inherent in purchasing a new property.

According to embodiments, the title or escrow company can initiate an email to those customers who provide an email address. This email would be automatically generated at the time that escrow is opened, at the time that title insurance is applied for, or at other appropriate times. The email may also be set up to be initiated once a predetermined benchmark or milestone is reached.

Communication 108, according to embodiments, explains the security issues associated with purchasing new property and offers locksmith services 106 at a reasonable price to be provided by a pre-qualified locksmith immediately after closing or at such time agreeable to the new owner. According to embodiments, the letter may further comprise other offers or useful suggestions for potential new owners of property. For example, communication 108 may solely make the offer of having the property rekeyed. However, other communications 108 may also advertise homeowners insurance policies or other revenue generating advertisements. The offered insurance policies may be connected to the rekeying of the property, allowing the potential new owner an opportunity to receive improved rates due to the increased security of having the property rekeyed. Other type services may similarly be combined to present the potential new owner of a property with a variety of useful services that may synergistically improve the overall offers presented.

According to embodiments, rekeying may be a service that is automatically arranged for the purchaser of property. Title, escrow, or insurance companies, as well as banks, may include rekeying as part of the non-rekeying service provided to the purchaser. For example, the cost of rekeying may be included in closing costs 112 paid by the purchaser to the title and escrow company. According to embodiments, a fee may be charged to the purchaser for rekeying in addition to the fee for the non-rekeying service provided. According to embodiments, a service provider such as an insurance company may opt not to charge the purchaser a fee; rather, the service provider providing the non-rekeying service would provide rekeying as a preventative measure against future losses arising from insecure properties.

Once the potential purchaser chooses to rekey his or her property in operation 110, the title or escrow company would establish an arrangement with a qualified and insured locksmith company 106 to perform the services in operation 105. The arrangement, according to embodiments, involves a fee paid to locksmith 106 and a fee retained by title and escrow company 104, according to embodiments. After the arrangement is made, the locksmith rekeys the property at a predetermined date, such as the date a current occupant of the property vacates the property, or at a future date to be mutually agreed upon between the locksmith and the potential new owner in operation 120. Depending on the timing that the property is rekeyed relative to the escrow and transfer of deed process, the keys could be delivered directly to the purchaser or delivered into escrow.

According to embodiments, payment of the locksmith would be handled by the escrow and title company. The fee for rekeying could then be passed onto the purchaser as part of the closing costs (e.g., in operation 112) or as an unrelated charge. The escrow and title company would pay the locksmith a portion of the fees collected. According to other embodiments, once the arrangement with the locksmith is made, the purchaser would pay the locksmith directly. Thereafter, the locksmith would pay the title and escrow company a finder's type fee. The title and escrow company may also charge the purchaser a premium price as part of orchestrating the rekeying, which in turn may allow the purchaser to save money for other services, such as insurance.

Additionally, the locksmith would have an opportunity to sell additional services and products to the purchaser if contact is made after the purchaser takes possession of the property in operation 122. To that end, the methods of the present disclosure allow both the locksmith and the title and escrow company to improve revenues. For example, locksmith 106 may offer to the purchaser an option to have keyless locks 122a, reprogram garage doors 122b, install alarm systems 122c, or other security related services. According to embodiments, escrow and title company 104 or other similarly situated entities may provide a similar arrangement with security alarm companies or house improvement companies.

According to embodiments and in the case of lending institutions, a letter or other appropriate communication would be generated at certain predetermined times, for example, when an application is made for a loan or refinancing of an existing debt. The communication could also be generated at other appropriate times, for example every few years or when a substantial increase or decrease in account value occurs, which might statistically correspond to a customer purchasing a property. The communication would explain the security issues and would offer locksmith services at a reasonable price to be provided by a pre-qualified locksmith at a mutually agreeable time. The billing for such services would be done through escrow or separately by agreement of the parties. Other variations that are disclosed herein are similarly contemplated.

According to embodiments and in the case of property and casualty insurance companies, a letter or other appropriate communication would be generated at one or more of the following times: (i) when an application for insurance is made by a customer, (ii) when the insurance company solicits a new customer, or (iii) when a claim is made by an insured. The letter would explain the security issues and insurance benefits to the insured and offer locksmith services at a reasonable price to be provided by a pre-qualified locksmith at mutually convenient time. The billing would be handled through the insurance company or separately by agreement. Other variations that are disclosed herein are similarly contemplated.

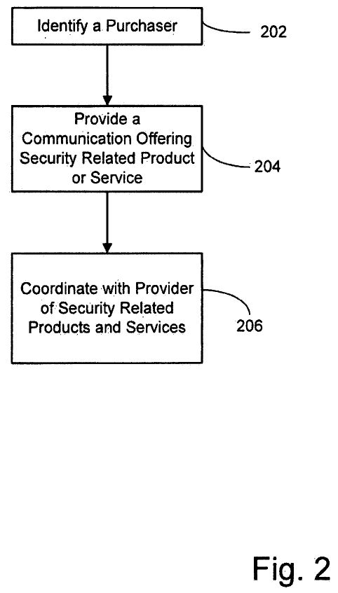

As illustrated in FIG. 2 and according to embodiments, the methods of the present disclosure require first identifying a purchaser of a property in operation 202. Generally, title and escrow companies, insurance companies, and banks, for example, are ideally situated to identify purchasers because of the non-security related service or good being offered or utilized provided by the title and escrow company, insurance company, bank, or other similarly situated company during the purchase of the property.

After the purchaser is identified, a communication is provided to the purchaser, as disclosed herein, in operation 204. The communication may be a letter, e-mail, verbal offer, or included as part of a contract for services. According to embodiments, insurance companies may automatically rekey a property in improve security; in this case the communication may simply comprise a notification or waiver for rekeying.

Finally, the title and escrow company, insurance company, bank, or other similarly situated company coordinates with a provider of the security related service or good in operation 206. The title and ecrow company, insurance company, bank, or other similarly situated company may then institute retain a revenues from the sale of the security related good or service in the form of a finders fee paid by the entity providing the good or service or directly charge the purchaser a fee for the good or service and pay an agreed amount to the entity providing the good or service, keeping the difference as a revenue source.

While the systems and methods have been described in terms of what are presently considered to be the most practical and preferred arrangements, it is to be understood that the disclosure need not be limited to the disclosed descriptions. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method comprising:
identifying a potential purchaser of a property;
providing a communication to the potential purchaser for security related products and services; and
coordinating with a provider of security-related products or services for the property for the purchaser;
wherein the identification of the purchaser is made in conjunction with the providing of an unrelated property acquisition-type service.

2. The method of claim 1, wherein the unrelated property acquisition-type service comprises escrow products and services; the providing of escrow products and services; the offer of title products and services; the providing of title products and services; the offer of insurance products and services; the providing of insurance products and services; the offer of banking products and services; the providing of banking products and services; the offer of loan-related products and services; or the providing of loan-related products and services.

3. The method of claim 1, wherein the security-elated product or service is rekeying of locks.

4. The method of claim 1, wherein the revenues collected as a result of the purchase of security related products or services is shared between the provider of the security-related product or service and the coordinator.

5. The method of claim 1, wherein the communication is a written communication.

6. The method of claim 1, wherein the communication is a oral communication.

7. The method of claim 1, wherein the communication is provided as part of a contract for the unrelated property acquisition-type service;
wherein the security-related service is provided automatically.

8. The method of claim 1, further comprising entering into a contractual relationship with the provider of security related products or services.

9. A product by the process of claim 1.

10. A method comprising:
offering rekeying services to a potential purchaser of a property;
wherein the offer is made by an entity offering escrow products or services; title products or services; insurance products or services; banking products or services; or lending products or services.

11. The method of claim 10, further comprising identifying the potential purchaser of the property.

12. The method of claim 11, wherein the identification of the purchaser is made in conjunction with the offer of escrow products and services; the providing of escrow products and services; the offer of title products and services; the providing of title products and services; the offer of insurance products and services; the providing of insurance products and services; the offer of banking products and services; the providing of banking products and services; the offer of loan-related products and services; or the providing of loan-related products and services.

13. A product by the process of claim 10.

14. A method comprising:
in conjunction with the offer of or providing of at least one of escrow, title, insurance, banking, or loan-related services:
identifying a purchaser of a property;
providing for a communication for the rekeying of the property's locks; and
coordinating with a locksmith to have the property's locks rekeyed.

15. The method of claim 14, wherein the at least one escrow, title, insurance, banking, or loan-related service provider contractually agrees with at least one locksmith to provide rekeying at a reduce fee.

16. The method of claim 15, wherein the difference between the fee paid to the locksmith and the fee charged to the purchaser of property is retained by the service provider.

17. The method of claim 14, wherein the rekeying is provided automatically as part of the services provided.

18. The method of claim 17, wherein a fee is charged to the purchaser of property for rekeying.

19. A product by the process of claim 14.
